(19) United States
(12) Patent Application Publication
(10) Pub. No.: US 2012/0222472 A1
(43) Pub. Date: Sep. 6, 2012

(54) COMPRESSION SENSOR GASKET ASSEMBLY

(76) Inventor: David M. Toth, Brighton, MI (US)

(21) Appl. No.: 13/412,071

(22) Filed: Mar. 5, 2012

Related U.S. Application Data
(60) Provisional application No. 61/448,680, filed on Mar. 3, 2011.

(51) Int. Cl. G01M 15/08

(52) U.S. Cl. 73/114.18

(57) ABSTRACT

A compression sensor gasket assembly includes a pressure sensor assembly having an annular, radially extending pressure sensor seal seat and a gasket body having opposite sides extending between an opening configured to register with a cylinder bore of an internal combustion engine and an outer periphery. The opposite sides of the gasket body are spaced from one another adjacent the opening by a known thickness and a circumferentially enclosed passage extends between the opposite sides into the opening. The passage has an annular, radially extending gasket seal seat. The gasket seal seat is formed within a distance equal to or less than about 3 times the thickness of the gasket body and the pressure sensor assembly is received at least in part the passage with the sensor seal seat being brought into operably sealed engagement with the gasket seal seat.

### CROSS-REFERENCE TO RELATED APPLICATION

This application claims the benefit of U.S. Provisional Application Ser. No. 61/448,680, filed Mar. 3, 2011, which is incorporated herein by reference in its entirety.

### BACKGROUND OF THE INVENTION

1. Technical Field

This invention relates generally to internal combustion engines, and more particularly to compression gaskets for forming a seal about a chamber within an internal combustion engine.

2. Related Art

Internal combustion engines have chambers in which high pressures are generated. Generally, a pair of members mate with one another to form the chamber or chambers, such as a cylinder head and engine block, for example, with a gasket being received between the members to provide a gas/fluid tight seal. In addition to the gasket, it is known to provide a separate pressure sensor to indicate the pressure within the chamber.

It is important that the pressure sensor not permit gas and/or fluid to leak from the chambers. Accordingly, it is important to provide a gas/fluid tight seal between the pressure sensor and the gasket. If the desired gas/fluid tight seal is not provided and maintained between the pressure sensor and the gasket during use, aside from a gas/fluid leak resulting, the pressure within the corresponding cylinder chamber will be negatively affected, thereby resulting in a service condition. Some attempts to form a seal between the pressure sensor and the gasket rely on a conical seal joint formed between a female conical seal seat in the gasket and a mating male conical seal surface on the sensor. The seal joint is typically formed a significant distance from the corresponding cylinder chamber, such as 10 mm or more, including a distance extending about half way between the cylinder bore and the outer periphery of the gasket or more, and thus, the sensor body extends over the distance from the seal joint to the cylinder chamber in an unsealed, generally unsupported manner.

With the sensor body extending over the distance from the seal joint to the cylinder chamber in an unsealed, generally unsupported manner, the annular region between the sensor body and the gasket typically become filled with soot from combustion residue within the cylinder chamber over a relatively short period of time, e.g. 100 hours. The soot build-up eventually hardens and forms a bond between the sensor body and the gasket, and thus, during service, the sensor can be very difficult, if not impossible to remove from the gasket body. In addition to complicating the removal of the sensor, the soot break loose and become deposited in the cylinder chamber. A further disadvantage caused by the build-up of soot is that the heat transfer of heat from the sensor body to the distance layer immediately adjacent the cylinder chamber is diminished, thereby causing undue heat stress on the sensor. In addition to the build-up of soot, the unsupported sensor body extending over the significant distance from the seal joint to the cylinder chamber is prone to vibration, which if bad enough, can be heard by the vehicle occupants.

### SUMMARY OF THE INVENTION

A compression sensor gasket assembly is provided for forming a reliable seal between a cylinder head and an engine block of an internal combustion engine and for sensing the pressure within the cylinder chambers of the engine. The gasket assembly includes a pressure sensor assembly having an annular, radially extending pressure sensor seal seat and a gasket body having opposite sides extending between an opening configured to register with a cylinder bore of an internal combustion engine and an outer periphery. The opposite sides of the gasket body are spaced from one another adjacent the opening by a known thickness and a circumferentially enclosed passage extends between the opposite sides into the opening. The passage has an annular, radially extending gasket seal seat. The gasket seal seat is formed within a distance equal to or less than about 3 times the thickness of the gasket body and the pressure sensor assembly is received at least in part the passage with the sensor seal seat being brought into operably sealed engagement with the gasket seal seat.

In accordance with a further aspect of the invention, the circumferentially enclosed passage has a reduced diameter portion extending between the seal seat and the opening and an enlarged diameter portion extending radially outwardly from the seal seat.

In accordance with a further aspect of the invention, the pressure sensor assembly has a cylindrical portion extending into the reduced diameter portion of the circumferentially enclosed passage wherein an annular gap extends between the reduced diameter portion of the circumferentially enclosed passage and the pressure sensor assembly.

### BRIEF DESCRIPTION OF THE DRAWINGS

These and other aspects, features and advantages of the invention will become more readily appreciated when considered in connection with the following detailed description of presently preferred embodiments and best mode, appended claims and accompanying drawings, in which:

FIG. 1 is a partial top perspective view of a gasket body assembly constructed in accordance with one presently preferred embodiment of the invention;

FIG. 2 is a bottom perspective view of the gasket body assembly of FIG. 1; and

FIG. 3 is cross-sectional view of the gasket body assembly taken generally along the line 3-3 of FIG. 1.

### DETAILED DESCRIPTION OF PRESENTLY PREFERRED EMBODIMENTS

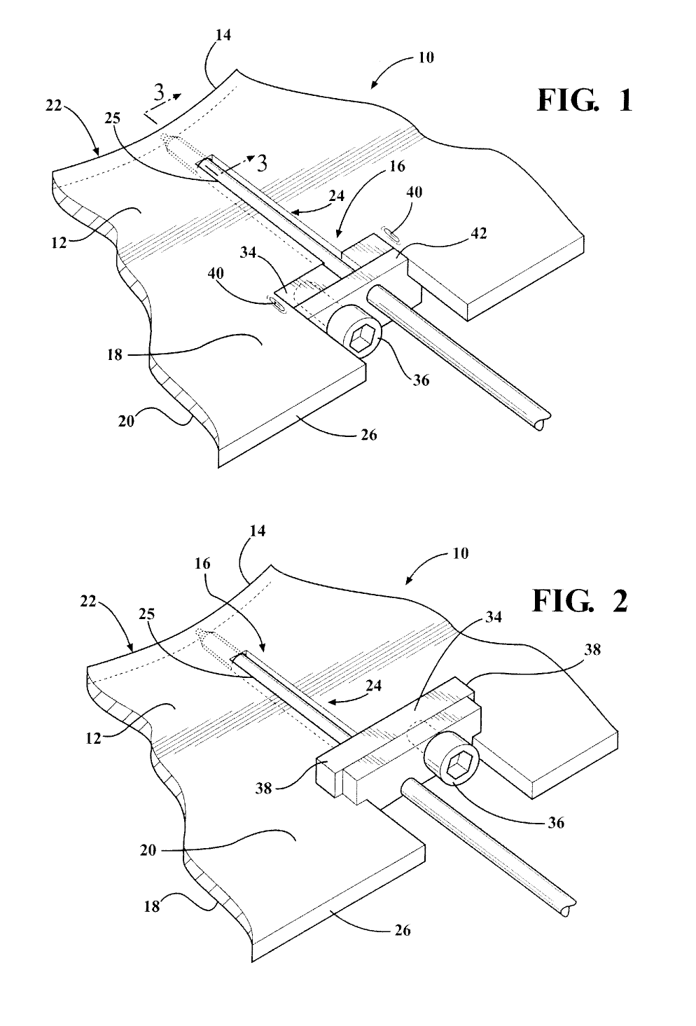

Referring in more detail to the drawings, FIG. 1 illustrates a portion of compression sensor gasket assembly, referred to hereafter as gasket assembly 10, constructed in accordance with one presently preferred embodiment of the invention. The gasket assembly 10 has a metal layer, such as a distance layer, referred to hereafter as gasket body 12, with one or more through openings, also referred to as openings or through passages 14, for the passage of fluid or gas therethrough, such as an opening configured to register in axial alignment with a cylinder bore, also referred to as cylinder chamber (not shown), for example. The gasket assembly 10 includes a pressure sensor assembly 16 at least partially releasably attached in sealed engagement with the gasket body 12. The pressure sensor assembly 16 includes a pressure sensor 17 that is configured at a distal end of the assembly 16 to sense pressure within the associated through passage 14 and within the cylinder bore being sealed. In service, the pressure sensor assembly 16 can be readily removed from the gasket body 12 and replaced, as necessary, without undue residue (soot) build-up complicating removal of the pressure sensor assembly 16. Accordingly, service of the pressure sensor assembly 16 is made easy, while the pressure sensor assembly 16 also exhibits precise temperature indications in use due to its having an enhanced ability to dissipate heat and its experiencing reduced vibration in use.

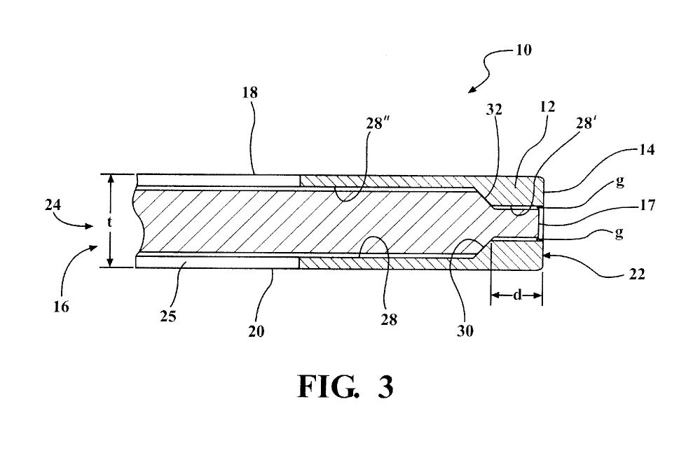

The gasket body 12 can be provided as a monolithic piece of material having flat or substantially flat sealing surfaces 18, 20 configured for sealed engagement directly with a cylinder head, engine block or one or more functional layers fabricated from a resilient metal (not shown), such as spring steel, for example, having sealing beads, including half and/or full sealing beads, as desired. The through passages 14 have an inner surface or periphery 22 configured to register with the passage being sealed, wherein, as shown in FIG. 3, the opposite sides 18, 20 are spaced from one another by a thickness (t) immediately adjacent the through passages 14. To facilitate attaching the pressure sensor assembly 16 to the gasket body 12, the gasket body 12 has a plurality of passages 24 extending from an outer periphery 26 into each through passage 14. The passage 24 can be formed in part as a recessed slot (not extending through the full thickness of the body 12); in part as a through slot (extending completely through the thickness of the body 12), and in part or fully as an enclosed passage, also referred to as tubular passage, extending between the opposite sealing surfaces 18, 20. For example, the passages 24 can be formed having through slots 25 extending through the opposite sides 18, 20 from an outer periphery 26 (the outer most portion of the gasket body 12) toward a respective through passage 14. The through slots 25 can be stamped, milled or otherwise machined through the opposite sealing surfaces 18, 20. In addition, a circumferentially enclosed tubular passage, represented as a drilled passage 28, extends from the respective through slot 25 radially inwardly between the opposite sides 16, 18 to the inner periphery 22. The drilled passage 28 can be sized, at least in part, having a close fit, such as a slight loose or line-to-line fit with a portion of the pressure sensor assembly 16, or it can be enlarged for receipt of an adaptor sleeve, seal, heat shield, or other type of fitting. As shown, the passage 28 has a smooth, non-threaded cylindrical surface, thereby allowing the pressure sensor assembly 16 to slide freely therein.

To facilitate forming the gas/fluid tight seal between the pressure sensor assembly 16 and the gasket body 12, an annular gasket body seal seat 30 is formed within the tubular passage 28, wherein the annular seal seat 30 is shown as having a radially extending female conical surface configured for operably sealed engagement with an annular radially extending sensor seal seat 32 on the pressure sensor assembly 16. As such, the passage 28 includes a reduced diameter portion 28′ extending between the seal seat 32 and the inner periphery 22 and an enlarged diameter portion 28″ extending radially outwardly from the seal seat 32. The sensor seal seat 32 is configured to mate with the gasket seal seat 30, and thus, in the embodiment shown, the sensor seal seat 32 has an outer male conical surface having the same or substantially the same angle of inclination as the gasket seal seat 30. The seal seat 30 in the gasket body 12 is formed within a predetermined distance (d) from the inner periphery 22, wherein the predetermined distance d is generally between about 0.5 to 3.0 times the thickness t of the gasket body 12, and preferably between 0.5 to 1 times the thickness t. As such, the length of the reduced diameter portion 28′ of the circumferentially enclosed tubular passage 28 which extends along the distance d between the seal seat 30 and the inner periphery 22 is minimized. Accordingly, the cylindrical portion of the pressure sensor assembly 16 that extends between the gas/fluid tight seal established between the respective seal seats 30, 32 and the inner periphery 22 is minimized. Accordingly, the vibration of the cylindrical portion of the pressure sensor assembly 16 extending over the and of the pressure sensor 17 itself is minimized. Further, the potential for the pressure sensor assembly 16 to be seized to the gasket body 12 via soot build-up over the reduced diameter portion 28′ is minimized, given the length of an annular gap (g) formed between the pressure sensor assembly 16 and the inner surface of the reduced diameter portion 28′ between the conical seal seat 30 and the inner periphery 22 in which the potential for soot buildup exists is minimized.

To facilitate attaching and locating the sensor assembly 16 to the gasket body 12, a fastening member, also referred to as fastener plate 34, is fixed to extend outwardly from the lower sealing surface 20, wherein the fastener plate 34 has at least one fastener opening formed therein to accommodate a fastener 36. The fastener plate 34 is shown extending flush or substantially flush with the upper sealing surface 18 and depending downwardly from the lower sealing surface 20. The fastener plate, as shown in FIG. 2, has flanges 38 extending laterally in abutment with the lower sealing surface 20, wherein an upper surface of the flanges 38 is fixed to the lower sealing surface 20, such as via a weld joint 40, e.g. laser welding. Accordingly, during assembly, the fastener 36 is extended through a fastener passage in a sensor mounting member 42 coupled to the sensor assembly 16 and then threaded in the fastener opening of the fastener plate 34.

During assembly, each pressure sensor 17 is received in its respective drilled passage 28 adjacent the inner periphery 22. Upon fastening the sensor mounting member 42 via threaded fasteners 36 to the fastener plate 34 of the gasket body 12, the pressure sensor 17 is automatically oriented and fixed in its sensing position relative to the inner periphery 22 of the through opening 14. Further, the sensor mounting member 42 is configured to exert a bias on the pressure sensor assembly 16 to maintain the seal seat 32 of the pressure sensor assembly 16 in sealed abutment against the seal seat 30 of the gasket body 12. Then, as desired, the fasteners 36 can be removed to readily remove the respective pressure sensor 17 from the gasket body 12 without concern of the pressure sensor 17 or the assembly 16 being seized to the gasket body 12.

Obviously, many modifications and variations of the present invention are possible in light of the above teachings. It is, therefore, to be understood that within the scope of the appended claims, the invention may be practiced otherwise than as specifically described.

What is claimed is:

1. A compression sensor gasket assembly, comprising:
a pressure sensor assembly having an annular, radially extending pressure sensor seal seat;
a gasket body having opposite sides extending between an opening configured to register with a cylinder bore of an internal combustion engine and an outer periphery, said opposite sides being spaced from one another adjacent said opening by a thickness, a circumferentially enclosed passage extending between said opposite sides into said opening, said passage having an annular, radially extending gasket seal seat; and
said seal seat being formed within a distance equal to or less than about 3 times said thickness of said gasket body and said pressure sensor being received at least in part said passage with said sensor seal seat being brought into operably sealed engagement with said gasket seal seat.

2. The compression sensor gasket assembly of claim 1 wherein said circumferentially enclosed passage has a reduced diameter portion extending between said seal seat and said opening and an enlarged diameter portion extending radially outwardly from said seal seat.

3. The compression sensor gasket assembly of claim 2 wherein said pressure sensor assembly has a cylindrical portion extending into said reduced diameter portion of said circumferentially enclosed passage.

4. The compression sensor gasket assembly of claim 3 wherein said gasket seal seat and said pressure sensor seal seat are conical.

5. The compression sensor gasket assembly of claim 4 wherein an annular gap extends between said reduced diameter portion of said circumferentially enclosed passage and said pressure sensor assembly.

6. The compression sensor gasket assembly of claim 1 wherein said seal seat is formed within a distance equal to or less than about 1 times said thickness of said gasket body.
